(19) United States
(12) Patent Application Publication
(10) Pub. No.: US 2005/0157794 A1
(43) Pub. Date: Jul. 21, 2005

(54) Scalable video encoding method and apparatus supporting closed-loop optimization

(75) Inventors: Su-hyun Kim, Seoul (KR); Woo-jin Han, Suwon-si (KR)

Correspondence Address: SUGHRUE MION, PLLC, 401 Castro Street, Ste 220, Mountain View, CA, 94041-2007, US

(73) Assignee: SAMSUNG ELECTRONICS CO., LTD.

(21) Appl. No.: 11/034,735

(22) Filed: Jan. 14, 2005

(30) Foreign Application Priority Data
Jan. 16, 2004 (KR) 10-2004-0003391

(51) Int. Cl. H04N 7/12

(52) U.S. Cl. 375/240.16; 375/240.12; 375/240.03; 375/240.19

(57) ABSTRACT

Provided are a method and apparatus for improving the quality of an image output from a decoder by reducing an accumulated error between an original frame available at an encoder and a reconstructed frame available at a decoder caused by quantization for scalable video coding supporting temporal scaling. A scalable video encoder includes a motion estimation unit that performs motion estimation on the current frame using one of previous reconstructed frames stored in a buffer as a reference frame and determines motion vectors, a temporal filtering unit that removes temporal redundancy from the current frame using the motion vectors, a quantizer that quantizes the current frame from which the temporal redundancy has been removed, and a closed-loop filtering unit that performs decoding on the quantized coefficient to create a reconstructed frame and provides the reconstructed frame as a reference for subsequent motion estimation. A closed-loop optimisation algorithm can be used in scalable video coding, thereby reducing an accumulated error introduced by quantization while alleviating an image drift problem.

### CROSS-REFERENCE TO RELATED APPLICATION

This application claims priority from Korean Patent Application No. 10-2004-0003391 filed on Jan. 16, 2004 in the Korean Intellectual Property Office, the disclosure of which is incorporated herein by reference in its entirety.

### BACKGROUND OF THE INVENTION

1. Field of the Invention

The present invention relates to a video compression method, and more particularly, to a method and apparatus for improving the quality of an image output from a decoder by reducing an accumulated error between an original frame input to encoder and a reconstructed frame by a decoder caused by quantization for scalable video coding supporting temporal scaling.

2. Description of the Related Art

With the development of information communication technology including the Internet, video communication as well as text and voice communication has dramatically increased. Conventional text communication cannot satisfy users' various demands, and thus multimedia services that can provide various types of information such as text, pictures, and music have increased. Multimedia data requires a large capacity of storage media and a wide bandwidth for transmission since the amount of multimedia data is usually large. Accordingly, a compression coding method is requisite for transmitting multimedia data including text, video, and audio.

A basic principle of data compression lies in removing data redundancy. Data can be compressed by removing spatial redundancy in which the same color or object is repeated in an image, temporal redundancy in which there is little change between adjacent frames in a moving image or the same sound is repeated in audio, or mental visual redundancy taking into account human eyesight and perception insensitivity to high frequency.

Most of video coding standards are based on motion compensation/estimation coding. The temporal redundancy is removed using temporal filtering based on motion compensation, and the spatial redundancy is removed using spatial transform.

A transmission medium is required to transmit multimedia generated after removing the data redundancy. Transmission performance is different depending on transmission media. Currently used transmission media have various transmission rates. For example, an ultrahigh-speed communication network can transmit data of several tens of megabits per second while a mobile communication network has a transmission rate of 384 kilobits per second.

To support transmission media having various speeds or to transmit multimedia at a rate suitable to a transmission environment, data coding methods having scalability may be suitable to a multimedia environment.

Scalability indicates a characteristic that enables a decoder or a pre-decoder to partially decode a single compressed bitstream according to conditions such as a bit rate, an error rate, and system resources. A decoder or a pre-decoder can reconstruct a multimedia sequence having different picture quality, resolutions, or frame rates using only a portion of a bitstream that has been coded according to a method having scalability.

In Moving Picture Experts Group-21 (MPEG-21) Part 13, scalable video coding is being standardized. A wavelet-based spatial transform method is considered as the strongest candidate for such standardization.

FIG. 1 is a schematic diagram of a typical scalable video coding system. An encoder 100 and a decoder 300 can be construed as a video compressor and a video decompressor, respectively.

The encoder 100 codes an input video/image 10, thereby generating a bitstream 20.

A pre-decoder 200 can extract a different bitstream 25 by variously cutting the bitstream 20 received from the encoder 100 according to an extraction condition, such as a bit rate, a resolution, or a frame rate, and as related with an environment of communication with the decoder 300 or mechanical performance of the decoder 300.

The decoder 300 reconstructs an output video/image 30 from the extracted bitstream 25. Extraction of a bit stream according to an extraction condition may be performed by the decoder 300 instead of the pre-decoder 200 or may be performed by both of the pre-decoder 200 and the decoder 300.

FIG. 2 shows the configuration of a conventional scalable video encoder. Referring to FIG. 2, the conventional scalable video encoder 100 includes a buffer 110, a motion estimation unit 120, a temporal filtering unit 130, a spatial transformer 140, a quantizer 150, and an entropy encoding unit 160. Throughout this specification, Fₙ and Fₙ₋₁ denote n- and n-1-th original frames in the current group of pictures (GOP) and Fₙ′ and Fₙ₋₁′ denote n- and n-1-th reconstructed frames in the current GOP.

First, an input video is split into several GOPs, each of which is independently encoded as a unit. The motion estimation unit 120 performs motion estimation on the n-th frame Fₙ in the GOP using the n-1-th frame Fₙ₋₁ in the same GOP stored in a buffer 110 as a reference frame to determine motion vectors. The n-th frame Fₙ is then stored in the buffer 110 for motion estimation for the next frame.

The temporal filtering unit 130 removes temporal redundancy between adjacent frames using the determined motion vectors and produces a temporal residual.

The spatial transformer 140 performs a spatial transform on the temporal residual and creates transform coefficients. For example, the spatial transform refers to discrete cosine transform (DCT), or wavelet transform.

The quantizer 150 performs quantization on the wavelet coefficients.

The entropy encoding unit 160 converts the quantized wavelet coefficients and the motion vectors determined by the motion estimation unit 120 into a bitstream 20.

A predecoder 200 (shown in FIG. 1) truncates a portion of the bitstream according to extraction conditions and delivers the extracted bitstream to the decoder 300 (also shown in FIG. 1). The decoder 300 performs the reverse operation to the encoder 100 and reconstructs the current n-th frame by referencing the previously reconstructed n-1-th frame Fₙ₋₁′.

The conventional video encoder 100 supporting temporal scalability has an open-loop structure to achieve signal-to-noise ratio (SNR) scalability.

Generally, the current video frame is used as a reference frame for the next frame during video encoding. While the previous original frame Fₙ₋₁ is used as a reference frame for the current frame in the open-loop encoder 100, the previous reconstructed video frame Fₙ₋₁′ with a quantization error is used as a reference frame for the current frame in the decoder 300. Thus, the error increases as the frame number increases in the same GOP. The accumulated error causes a drift in a reconstructed image.

Since an encoding process is performed to determine a residual between original frames and quantize the residual, the original frame Fₙ is defined by Equation (1):
Fₙ=Dₙ+Fₙ₋₁ (1)

where Dₙ is a residual between the original frames Fₙ and Fₙ₋₁ and Dₙ′ is a quantized residual.

Since a decoding process is preformed to obtain the current reconstructed frame Fₙ′ using the quantized residual Dₙ′ and the previous reconstructed frame Fₙ₋₁′, the current reconstructed frame Fₙ′ is defined by Equation (2):
Fₙ′=Dₙ′+Fₙ₋₁′ (2)

There is a difference between the original frame Fₙ and the frame Fₙ′ that undergoes encoding and decoding of the original frame Fₙ, that is, between two terms on the right-hand side of Equation (1) and corresponding terms of Equation (2). The difference between the first terms Dₙ and Dₙ′ on the right-hand sides of Equations (1) and (2) occurs inevitably during quantization for video compression and decoding. However, the difference between the second terms Fₙ₋₁ and Fₙ₋₁′ may occur due to a difference between reference frames by the encoder and the decoder and accumulates to cause an error as the number of processed frames increases.

When encoding and decoding processes are performed on the next frame, the next original frame and reconstructed frame Fₙ₊₁ and Fₙ₊₁′ are defined by Equations (3) and (4):
Fₙ₊₁=Dₙ₊₁+Fₙ (3)
Fₙ₊₁′=Dₙ₊₁′+Fₙ′ (4)

If Equations (1) and (2) are substituted into Equations (3) and (4), respectively, Equations (5) and (6) are obtained:
Fₙ₊₁=Dₙ₊₁+Dₙ+Fₙ₋₁ (5)
Fₙ₊₁′=Dₙ₊₁′+Dₙ′+Fₙ₋₁′ (6)

Consequently, an error Fₙ₊₁-Fₙ₊₁′ in the next frame contains a difference between Dₙ₊₁ and Dₙ₊₁′ contains a difference between Dₙ and Dₙ′ transferred from the current frame as well as an inevitable difference between Dₙ₊₁ and Dₙ₊₁′ caused by quantization and a difference between Fₙ₋₁ and Fₙ₋₁′ due to the use of different reference frames. The accumulation of an error continues until a frame being encoded independently without reference to another frame appears.

Representative examples of temporal filtering techniques for scalable video coding include Motion Compensated Temporal Filtering (MCF), Unconstrained Motion Compensated Temporal Filtering (UMCTF), and Successive Temporal Approximation and Referencing (STAR). Details of the UMCTF technique are described in U.S. Published Application No. US2003/0202599, and an example of a STAR technique is described in an article entitled ‘Successive Temporal Approximation and Referencing (STAR) for improving MCTF in Low End-to-end Delay Scalable Video Coding’ (ISO/IEC JTC 1/SC 29/WG 11, MPEG2003/M10308, Hawaii, USA, Dec 2003).

Since these approaches perform motion estimation and temporal filtering in an open-loop fashion, they suffer from problems as described with reference to FIG. 2. However, no real solution has yet been proposed.

### SUMMARY OF THE INVENTION

The present invention provides a closed-loop filtering method for improving degradation in image equality resulting from an accumulated error between an original image available at an encoder and a reconstructed image available at a decoder introduced by quantization.

According to an aspect of the present invention, there is provided a scalable video encoder comprising: a motion estimation unit that performs motion estimation on the current frame using one of previous reconstructed frames stored in a buffer as a reference frame and determines motion vectors; a temporal filtering unit that removes temporal redundancy from the current frame using the motion vectors; a quantizer that quantizes the current frame from which the temporal redundancy has been removed; and a closed-loop filtering unit that performs decoding on the quantized coefficient to create a reconstructed frame and provides the reconstructed frame as a reference for subsequent motion estimation.

According to another aspect of the present invention, there is provided a scalable video encoding method comprising: performing motion estimation on the current frame using one of previous reconstructed frames stored in a buffer as a reference frame and determining motion vectors; removing temporal redundancy from the current frame using the motion vectors; quantizing the current frame from which the temporal redundancy has been removed; and performing decoding on the quantized coefficient to create a reconstructed frame and providing the reconstructed frame as a reference for subsequent motion estimation.

### BRIEF DESCRIPTION OF THE DRAWINGS

The above and other features and advantages of the present invention will become more apparent by describing in detail exemplary embodiments thereof with reference to the attached drawings in which:

FIG. 1 shows the overall configuration of a schematic diagram of a typical scalable video coding system;

FIG. 2 shows the configuration of a conventional scalable video encoder; FIG. 3 shows the configuration of a closed-loop scalable video encoder according to an embodiment of the present invention;

FIG. 4 is a schematic diagram of a predecoder used in scalable video coding according to an embodiment of the present invention;

FIG. 5 is a schematic diagram of a scalable video decoder according to an embodiment of the present invention;

FIG. 6 illustrates a difference between errors introduced by conventional open-loop coding and closed-loop coding according to the present invention when a predecoder is used.

FIG. 7 is a flowchart illustrating the operation of an encoder according to an embodiment of the present invention;

FIGS. 8A and 8B illustrate key concepts in Unconstrained Motion Compensated Temporal Filtering (UMCTF) and Successive Temporal Approximation and Referencing (STAR) according to an embodiment of the present invention;

FIG. 9 is a graph of signal-to-noise ratio (SNR) vs. bitrate to compare the performance between closed-loop coding according to the present invention and conventional open-loop coding; and

FIG. 10 is a schematic diagram of a system for performing an encoding method according to an embodiment of the present invention.

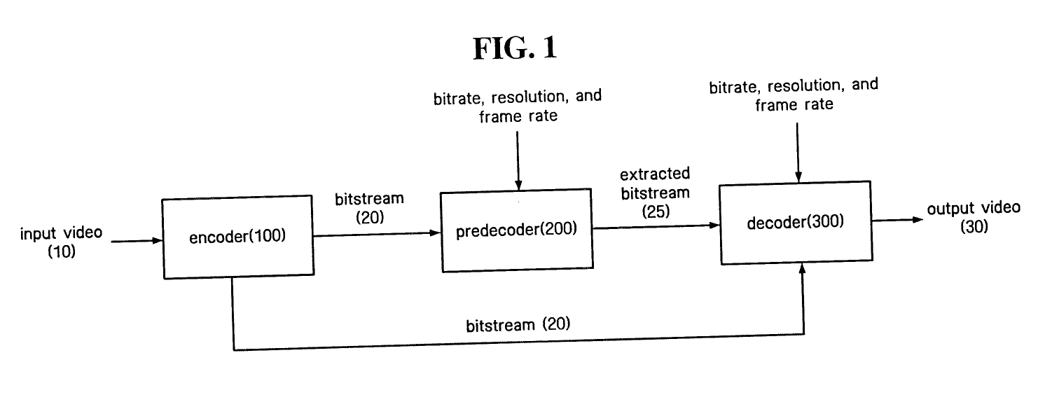

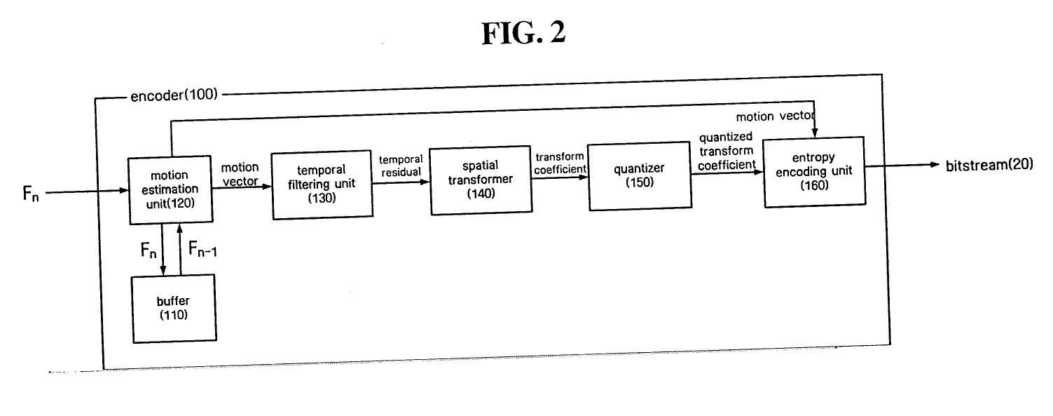

### DETAILED DESCRIPTION OF THE INVENTION

The advantages, features of the present invention and methods for accomplishing the same will now be described more fully with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the same reference numerals in different drawings represent the same element.

To improve problems in the open-loop coding, the important feature of the present invention is that a quantized transform coefficient is entropy encoded and at the same time decoded to create a reconstructed frame at an encoder terminal, and the reconstructed frame is used as a reference for motion estimation and temporal filtering of a future frame. This is intended to remove an accumulated error by providing the same environment as in a decoder terminal.

FIG. 3 shows the configuration of a closed-loop scalable video encoder according to an embodiment of the present invention. Referring to FIG. 3, a closed-loop scalable video encoder 400 includes a motion estimation unit 420, a temporal filtering unit 430, a spatial transformer 440, a quantizer 450, an entropy encoding unit 460, and a closed-loop filtering unit 470. First, an input video is partitioned into several groups of pictures (GOPs), each of which is encoded as a unit.

The motion estimation unit 420 performs motion estimation on an n-th frame Fₙ in the current GOP using an n-1-th frame Fₙ₋₁′ in the same GOP reconstructed by the closed-loop filtering unit 470 and stored in a buffer 410 as a reference frame. The motion estimation unit 420 also determines motion vectors. The motion estimation may be performed using hierarchical variable size block matching (HVSBM).

The temporal filtering unit 430 decomposes frames in GOP into high and low frequency frames in direction of a temporal axis using the values of motion vectors determined by the motion estimation unit 420 and removes temporal redundancies. For example, an average of frames may be defined as a low-frequency component, and half of a difference between two frames may be defined as a high-frequency component. Frames are decomposed in units of GOPs. Frames may be decomposed into high- and low-frequency frames by comparing pixels at the same positions in two frames without using a motion vector. However, the method not using a motion vector is less effective in reducing temporal redundancy than the method using a motion vector.

In other words, when a portion of a first frame is moved in a second frame, an amount of a motion can be represented by a motion vector. The portion of the first frame is compared with a portion to which a portion of the second frame at the same position as the portion of the first frame is moved by the motion vector, that is, a temporal motion is compensated. Thereafter, the first and second frames are decomposed into low- and high-frequency frames.

Hereinafter, the low-frequency frame can be defined as an original input frame or an updated frame that influenced by information of the neighbor frames (temporally front frame and rear frame).

Temporal filtering unit 430 repeatedly decomposes low- and high-frequency frames by hierarchical order so as to support temporal scalability

For the hierarchical temporal filtering, Motion Compensated Temporal Filtering (MCTF), Unconstrained Motion Compensated Temporal Filtering (UMCTF) or Successive Temporal Approximation and Referencing (STAR) may be used.

The spatial transformer 440 removes spatial redundancies from the frames from which the temporal redundancies have been removed by the temporal filtering unit 430 and creates transform coefficients. The spatial transform method may include a Discrete Cosine Transform (DCT), or wavelet transform. The spatial transformer 440 using DCT may creates DCT coefficients, and the spatial transformer 440 using wavelet transform may creates wavelet coefficients.

Referring back to FIG. 3, the quantizer 450 performs quantization on transform coefficients obtained by the spatial transformer 440. The quantization means the process of expressing the transform coefficients formed in arbitrary real values by discrete values, and matching the discrete values with indexes according to the predetermined quantization table.

Particularly, if the transform coefficients are wavelet coefficients, the quantizer 450 may use an embedded quantization method.

An Embedded Zerotrees Wavelet (EZW) algorithm, Set Partitioning in Hierarchical Trees (SPIHT), or Embedded ZeroBlock Coding (EZBC) may be used to perform the embedded quantization.

The quantization algorithms use dependency present in dependence on hierarchical spatiotemporal trees, thus achieving higher compression efficiency. Spatial relationships between pixels are expressed in a tree shape. Effective coding can be carried out using the fact that when a root in the tree is 0, children in the tree have a high probability of being 0. While pixels having relevancy to a pixel in the L band are being scanned, algorithms are performed.

The entropy encoding unit 460 converts the transform coefficients quantized by the quantizer 450, motion vector information generated by the motion estimation unit 420, and header information into a compressed bitstream suitable for transmission or storage. Examples of the coding method include a predictive coding method, a variable-length coding method (typically Huffmann coding), and an arithmetic coding method.

The transform coefficient quantized by the quantizer 450 is also input to the closed-loop filtering unit 470 proposed by the present invention.

The closed-loop filtering unit 470 performs decoding on the quantized transform coefficient to create a reconstructed frame and provides the reconstructed frame as a reference frame for subsequent motion estimation. The closed-loop filtering unit 470 includes an inverse quantizer 471, an inverse spatial transformer 472, an inverse temporal filtering unit 473, and in-loop filtering unit 474.

The dequantizer 471 decodes the transform coefficient received from the quantizer 450. That is, the dequantizer 450 performs the inverse of operations of the quantizer 450.

The inverse spatial transformer 472 performs inverse of operations of the spatial transformer 440. That is, the transform coefficient received from the quantizer 471 is inversely transformed and reconstructed into a frame in a spatial domain. If the transform coefficient is a wavelet coefficient, the wavelet coefficient is inversely wavelet transformed to create a temporal residual frame.

The inverse temporal filtering unit 473 performs the reverse operation to the temporal filtering unit 430 using the motion vector determined by the motion estimation unit 420 and the temporal residual frame created by the inverse spatial transformer 472 and creates a reconstructed frame, i.e., a frame decoded to be recognized as a specific image.

The reconstructed frame may then be post-processed by the in-loop filtering unit 474 such as deblock filter or deringing filter to improve image quality. In this case, a final reconstructed frame Fₙ′ is created during post-processing. When the closed-loop encoder 400 does not include the in-loop filter 474, the reconstructed frame created by the inverse temporal filtering unit 473 is the final reconstructed frame Fₙ′.

When the closed-loop encoder 400 includes the in-loop filtering unit 474 the buffer 410 stores the reconstructed frame Fₙ′ created by the in-loop filtering unit 474 and then provides the same as a reference frame that is used to perform motion estimation on a future frame.

While it has been shown in FIG. 3 that a frame has been used as a reference for motion estimation of a frame immediately following the same, the present invention is not limited thereto. Rather, it should be noted that a temporally subsequent frame may be used as a reference for prediction of a frame immediately preceding it or one of discontinuous frames may be used as a reference for prediction of another frame depending on the selected motion estimation or temporal filtering method.

A feature of the present invention lies in the construction of the encoder 400. The predecoder 200 or the decoder 300 may use a conventional scalable video coding algorithm.

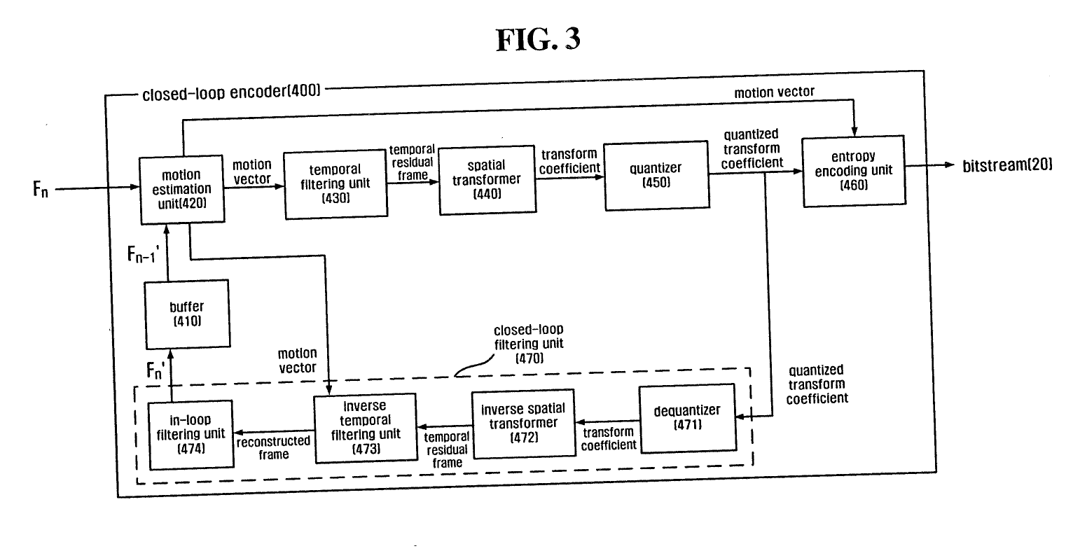

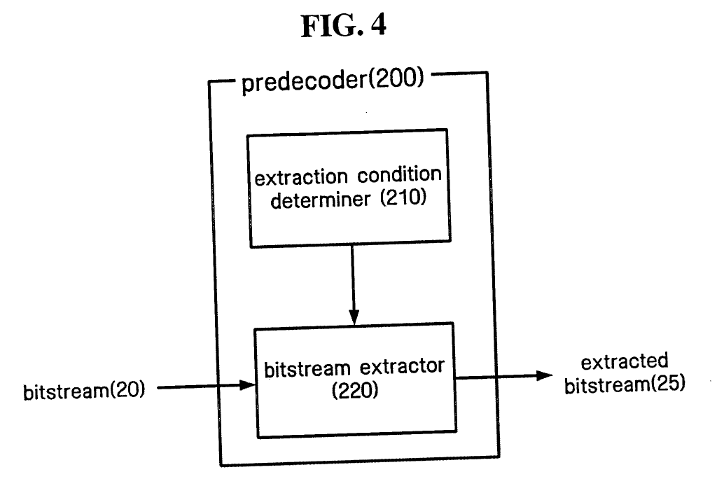

Referring to FIG. 4, the predecoder 200 includes an extraction condition determiner 210 and a bitstream extractor 220.

The extraction condition determiner 210 determines extraction conditions under which a bitstream received from the encoder 400 will be truncated. The extraction conditions mean a bitrate that is an indication for the image quality, a resolution that determines the display size of an image, and a frame rate that determines how many frames can be displayed per second. Scalable video coding provides scalabilities in terms of bitrate, resolution, and frame rate by truncating a portion of a bitstream encoded according to these conditions.

The bitstream extraction unit 220 cuts a portion of the bitstream received from the encoder 400 according to the determined extraction conditions and extracts a new bitstream.

When a bitstream is extracted according to a bitrate, the transform coefficients quantized by the quantizer 450 can be truncated in a descending order to reach the number of bits allocated. When a bistream is extracted according to a resolution, a transform coefficient representing an appropriate subband image can be truncated. When a bitstream is extracted according to a frame rate, only frames required at a temporal level can be truncated.

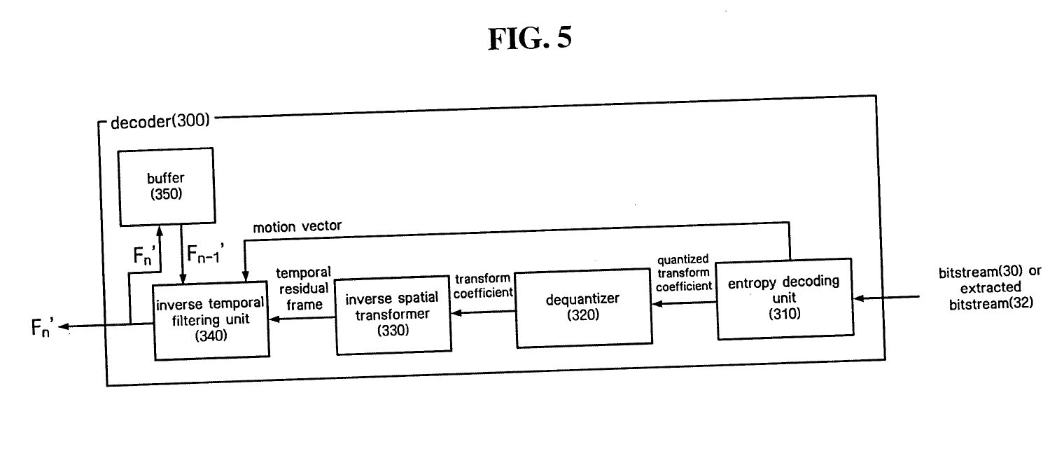

FIG. 5 is a schematic diagram of a scalable video decoder 300. Referring to FIG. 5, the scalable video decoder 300 includes an entropy decoding unit 310, a dequantizer 320, an inverse spatial transformer 330, and an inverse temporal filtering unit 340.

The entropy decoding unit 310 performs the inverse of operations of the entropy encoding unit 460 and obtains motion vectors and texture data from an input bitstream 30 or 25.

The dequantizer 320 dequantizes the texture data and reconstructs transform coefficients. The dequantization means the process of reconstructing the transform coefficients matched by the indexes created in encoder 100. Matching relationship between the indexes and the transform coefficents may be transmitted by encoder 100, or predefined between encoder 100 and decoder 300. The inverse spatial transformer 472 of the encoder 400, the inverse spatial transformer 330 receives the created transform coefficient to output a temporal residual frame.

The inverse temporal filtering unit 340 outputs a final reconstructed frame Fₙ′ by referencing the previous reconstructed frame Fₙ₋₁′ and using the motion vector received from the entropy decoding unit 310 and the temporal residual frame and stores the final reconstructed frame Fₙ′ in a buffer 350 as a reference for prediction of subsequent frames.

While it has been shown and described in FIGS. 3, 4, and 5 that the encoder 400, the predecoder 200, and the decoder 300 are all separate devices, those skilled in the art readily recognize that one and/or the other of encoder 400 and decoder 300 may include the predecoder 200.

Reducing an error between original and reconstructed frames as described with Equations (1)-(6) above when the present invention is applied will now be described. It is assumed that no extraction step is performed by the predecoder 200 for comparison with the error described with Equations (1)-(6).

First, where Dₙ is a residual between an original frame Fₙ and the previous reconstructed frame Fₙ₋₁′ and Dₙ′ is a quantized residual, the original frame Fₙ is defined by Equation (7):
Fₙ=Dₙ+Fₙ₋₁′ (7)

Since a decoding process is performed to obtain a current reconstructed frame Fₙ′ using the quantized residual Dₙ′ and the previous reconstructed frame Fₙ₋₁′, Fₙ′ is defined by Equation (8):
Fₙ′=Dₙ′+Fₙ₋₁′ (8)

There is only a difference between the first terms Dₙ and Dₙ′ of the original frame Fₙ (Equation (7)) and the frame Fₙ′ (Equation (8)) that undergoes encoding and decoding of the original frame Fₙ. The difference between the first terms Dₙ and Dₙ′ on the right-hand sides of Equations (1) and (2) occurs inevitably during video compression quantization and decoding. In contrast to conventional video coding, there is no difference between the second terms on the right-hand sides of the Equations (7) and (8).

When the encoding and decoding processes are performed on the next frame, an original next frame Fₙ₊₁ and a next reconstructed frame are defined by Equations (9) and (1), respectively:
Fₙ₊₁=Dₙ₊₁+Fₙ′ (9)
Fₙ₊₁′=Dₙ₊₁′+Fₙ′ (10)

If Equation (8) is substituted into Equations (9) and (10), Equations (11) and (12) are obtained:
Fₙ₊₁=Dₙ₊₁+Dₙ′+Fₙ₋₁′ (11)
Fₙ₊₁′=Dₙ₊₁′+Dₙ′+Fₙ₋₁′ (12)

Upon comparison between Equations (11) and (12), an error Fₙ₊₁-Fₙ₊₁′ in the next frame contains only a difference between Dₙ₊₁ and Dₙ₊₁′. Thus, as the number of processed frames increases, an error is not accumulated.

While the error has been described with Equations (7)-(12) assuming that the encoded bitstream is directly decoded by the decoder 300, a different amount of error may occur when a portion of the encoded bistream is truncated by the predecoder 200 and then decoded by the decoder 300.

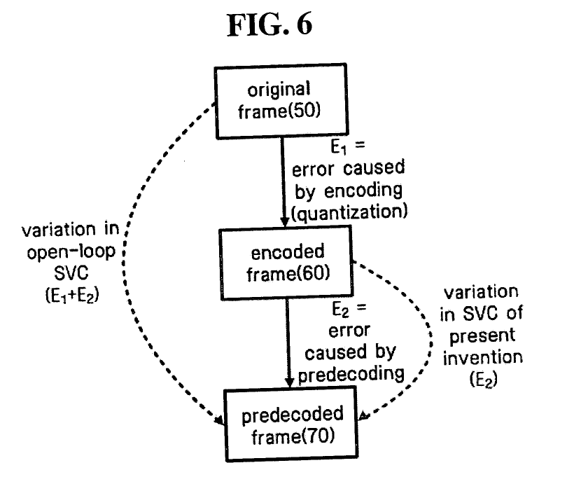

Referring to FIG. 6, an otherwise conventional open-loop scalable video coding (SVC) scheme suffers from an error E₁ (described with Equations (1)-(6)) that occurs while an original frame 50 is encoded (precisely, quantized) to produce an encoded frame 60, and an error E₂ that occurs while the encoded frame 60 is truncated to produce a predecoded frame 70.

Conversely, a SVC scheme according to the present invention suffers from only the error E₂ that occurs during predecoding.

Consequently, the present invention is advantageous over the conventional one in reducing an error between original and reconstructed frames, regardless of the use of a predecoder.

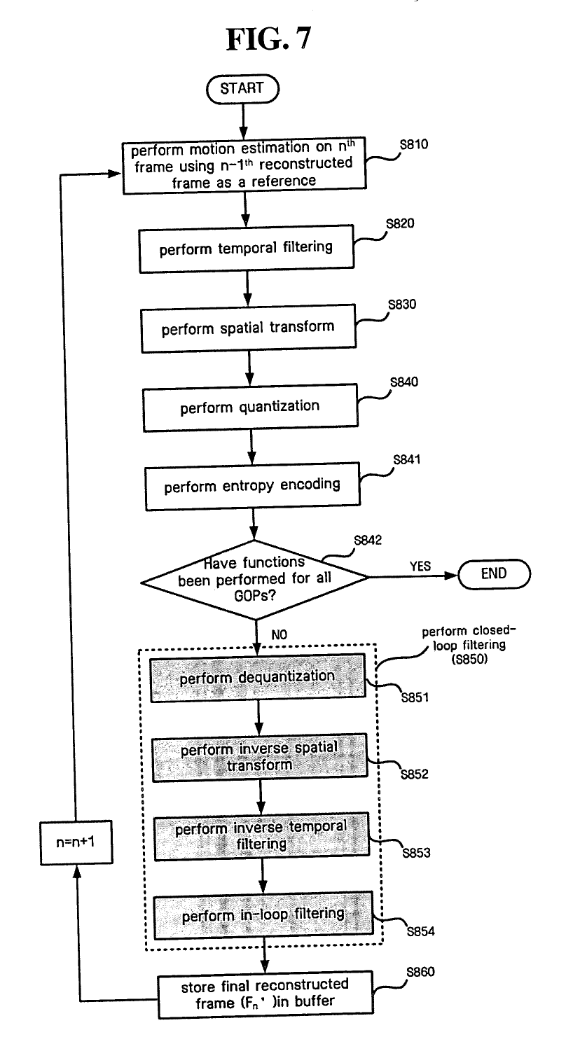

FIG. 7 is a flowchart illustrating the operations of the encoder 400 according to the present invention.

Referring to FIG. 7, in function S810, motion estimation is performed on the current n-th frame Fₙ using the previous n-1-th reconstructed frame Fₙ₋₁′ as a reference frame to determine motion vectors. In function S820, temporal filtering is performed using the motion vectors to remove temporal redundancy between adjacent frames.

In function S830, a spatial transform is performed to remove spatial redundancy from the frame from which the temporal redundancy has been removed and create a transform coefficient. In function S840, quantization is performed on the transform coefficient.

In function S841, the transform coefficient subjected to quantization, the motion vector information, and header information is entropy encoded into a compressed bitstream.

In function S842, it is determined whether the above functions S810-S841 have been performed for all GOPs. If so (yes in function S842), the above process terminates. If not (no in function S842), closed-loop filtering (that is, decoding) is performed on the quantized transform coefficient to create a reconstructed frame and provide the same as a reference for a subsequent motion estimation process in function S850.

The closed-loop filtering process, that is, function 850, will now be described in more detail. In function S851, inverse quantization is performed on the input transform coefficient subjected to quantization to create a transform coefficient before quantization.

In function S852, the created transform coefficient is inversely transformed to create a reconstructed frame in a spatial domain. In function S853, the motion vectors determined by the motion estimation unit 420 and the frame in a spatial domain are used to create a reconstructed frame.

To perform in-loop filtering, post-processing such as deblocking or deringing is performed on the reconstructed frame to create a final reconstructed frame Fₙ′ in function S854.

In function S860, the final reconstructed frame Fₙ′ is stored in a buffer and provided as a reference for motion estimation of subsequent frames.

While it has been shown and illustrated with reference to FIG. 7 that a frame has been used as a reference for motion estimation of a frame immediately following the frame, a temporally subsequent frame may be used as a reference for prediction of a frame immediately preceding it or one of discontinuous frames may be used as a reference for prediction of another frame depending on a motion estimation or temporal filtering method chosen.

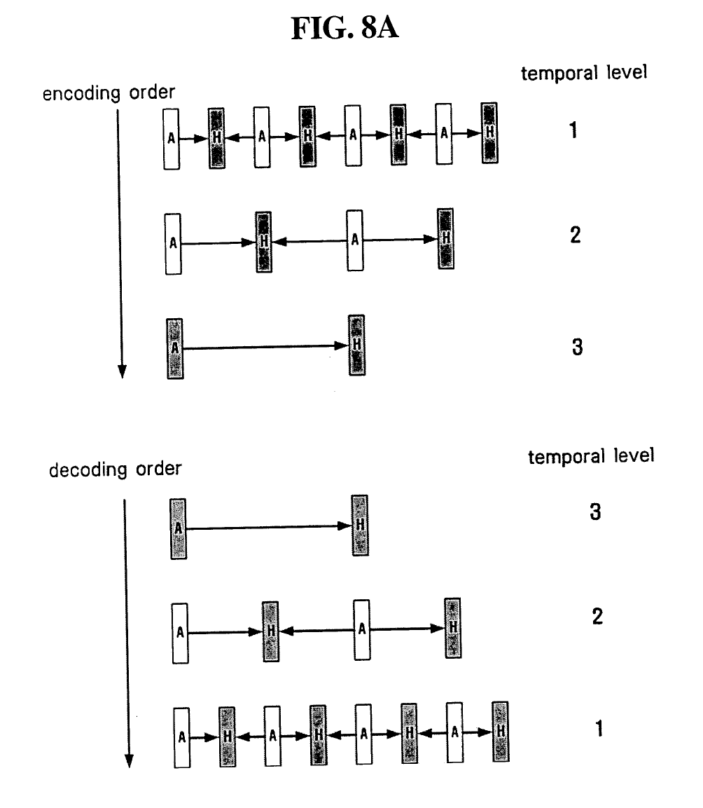

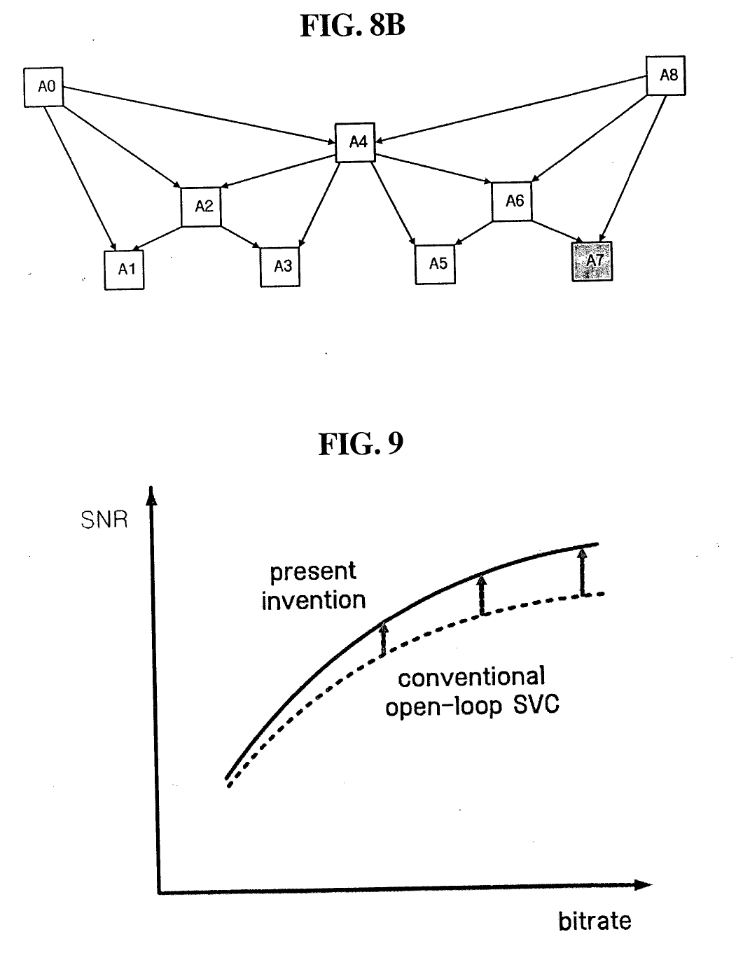

The invention's closed-loop filtering is advantageous for filtering schemes (which do not use update process, and has intra-frames unchanged) such as Unconstrained Motion Compensated Temporal Filtering (UMCTF) as illustrated in FIG. 8A and Successive Temporal Approximation and Referencing (STAR) as illustrated in FIG. 8B. Intra-frame refers to a frame that is independently encoded without reference to other frames. As for MCTF schemes which utilize an updating process, the closed-loop filtering may be less efficient than as for the schemes that do not use an updating process.

FIG. 9 is a graph of signal-to-noise ratio (SNR) vs. bitrate to compare the performance between closed-loop coding according to the present invention and conventional open-loop coding. As is evident by the graph, while a drift of an image scaled by a predecoder occurs in the original frame 50 when conventional open-loop SVC is used, the same occurs in the encoded frame 60 when the present invention is applied, thus mitigating this drift problem. While a SNR after optimization in the present invention is similar to that in conventional open-loop SVC at a low bitrate, it increases at a higher bitrate.

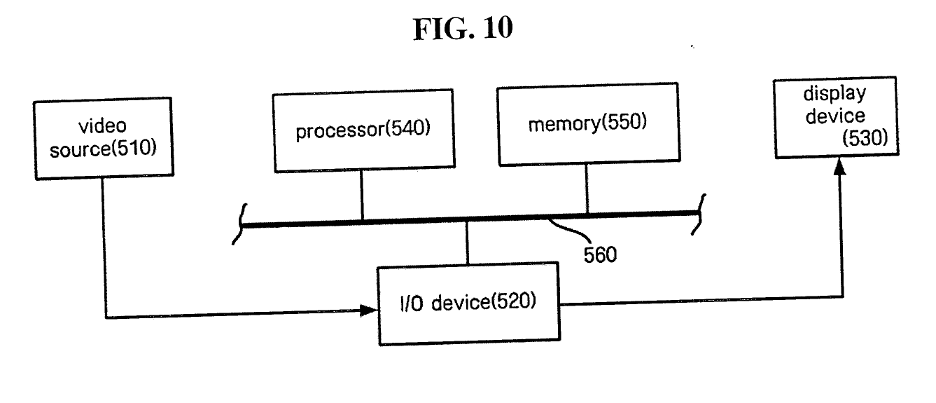

FIG. 10 is a schematic diagram of a system for performing an encoding method according to an embodiment of the present invention. The system may be a TV, a set-top box, a laptop computer, a palmtop computer, a personal digital assistant (PDA), a video/image storage device (e.g., video cassette recorder (VCR)), or digital video recorder (DVR). The system may also be a combination of the devices or an apparatus incorporating them. The system may include at least one video source 510, at least one input/output (I/O) device 520, a processor 540, a memory 550, and a display device 530.

The video source 510 may be a TV receiver, a VCR, or other video storage device. The video/image source 510 may indicate at least one network connection for receiving a video or an image from a server using Internet, a wide area network (WAN), a local area network (LAN), a terrestrial broadcast system, a cable network, a satellite communication network, a wireless network, a telephone network, or the like. In addition, the video/image source 510 may be a combination of the networks or one network including a part of another network among the networks.

The I/O device 520, the processor 540, and the memory 550 communicate with one another via a communication medium 560. The communication medium 560 may be a communication bus, a communication network, or at least one internal connection circuit. Input video/image data received from the video/image source 510 can be processed by the processor 540 using to at least one software program stored in the memory 550 and can be processed by the processor 540 to generate an output video/image provided to the display unit 530.

In particular, the at least one software program stored in the memory 550 includes a scalable wavelet-based codec that performs the coding method according to the present invention. The codec may be stored in the memory 550, read from a storage medium such as CD-ROM or floppy disk, or downloaded from a server via various networks. The codec may be replaced with a hardware circuit or a combination of software and hardware circuits according to the software program.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, it is to be understood that the above-described embodiments have been provided only in a descriptive sense and will not be construed as placing any limitation on the scope of the invention.

The present invention uses a closedloop optimisation algorithm in scalable video coding, thereby reducing an accumulated error introduced by quantization while alleviating an image drift problem.

The present invention also uses a post-processing filter such as a deblock filter or a deringing filter in the closed-loop, thereby improving the image quality.

1. A scalable video encoder comprising:
a motion estimation unit that: i) performs motion estimation on the current frame using one of previous reconstructed frames stored in a buffer as a reference frame and ii) determines motion vectors;
a temporal filtering unit that removes temporal redundancy from the current frame using the motion vectors in a hierarchical structure for supporting temporal scalability;
a quantizer that quantizes the current frame from which the temporal redundancy has been removed; and
a closed-loop filtering unit that performs decoding on the quantized coefficient to create a reconstructed frame and provides the reconstructed frame as a reference for subsequent motion estimation.

2. The scalable video encoder of claim 1, further comprising a spatial transformer that removes spatial redundancy from the current frame from which the temporal redundancy has been removed before quantization.

3. The scalable video encoder of claim 2, wherein a wavelet transform is used to remove the spatial redundancy.

4. The scalable video encoder of claim 1, further comprising an entropy encoding unit that converts: i) a coefficient quantized by the quantizer, ii) the motion vectors determined by the motion estimation unit, and iii) header information into a compressed bitstream.

5. The scalable video encoder of claim 2, wherein the closed-loop filtering unit comprises:
an inverse quantizer that receives a coefficient quantized by the quantizer and performs inverse quantization;
an inverse spatial transformer that transforms the coefficient subjected to the inverse quantization for reconstruction into a frame in a spatial domain; and
an inverse temporal filtering unit that: i) performs an inverse of the operations of the temporal filtering unit using the motion vectors determined by the motion estimation unit and a temporal residual frame created by the inverse spatial transformer and ii) creates a reconstructed frame.

6. The scalable video encoder of claim 5, wherein the closed-loop filtering unit further comprises an in-loop filter that performs post-processing on the reconstructed frame in order to improve an image quality.

7. A scalable video encoding method comprising:
performing motion estimation on a current frame using a previously reconstructed frame stored in a buffer as a reference frame;
determining motion vectors;
removing temporal redundancy from the current frame using the motion vectors;
quantizing the current frame from which the temporal redundancy has been removed; and
performing decoding on a quantized coefficient to create a reconstructed frame; and
providing the reconstructed frame as a reference for subsequent motion estimation.

8. The scalable video encoding method of claim 7 further comprising, before quantizing, removing spatial redundancy from the current frame from which the temporal redundancy has been removed.

9. The scalable video encoding method of claim 8, wherein a wavelet transform is used to remove the spatial redundancy.

10. The scalable video encoding method of claim 7, further comprising converting: i) the quantized coefficient, ii) the determined motion vectors, and iii) header information into a compressed bitstream.

11. The scalable video encoding method of claim 7, wherein the performing of decoding comprises:
receiving the quantized coefficient and performing inverse quantization;
transforming the coefficient subjected to the inverse quantization for reconstruction into a frame in a spatial domain; and
creating the reconstructed frame using the motion vectors and a temporal residual frame.

12. The scalable video encoding method of claim 11, wherein the performing of decoding further comprises performing post-processing on the reconstructed frame to improve image quality.

13. A recording medium having a computer readable program recorded thereon, the program causing a computer to execute the method of claim 7.

14. A recording medium having a computer readable program recorded thereon, the program causing a computer to execute the method of claim 13, the method further comprising, before quantizing, removing spatial redundancy from the current frame from which the temporal redundancy has been removed.

15. A recording medium having a computer readable program recorded thereon, the program causing a computer to execute the method of claim 13, wherein a wavelet transform is used to remove the spatial redundancy.

16. A recording medium having a computer readable program recorded thereon, the program causing a computer to execute the method of claim 13, the method further comprising converting: i) the quantized coefficient, ii) the determined motion vectors, and iii) header information into a compressed bitstream.

17. A recording medium having a computer readable program recorded thereon, the program causing a computer to execute the method of claim 13, wherein the performing of decoding comprises:
receiving the quantized coefficient and performing inverse quantization;
transforming the coefficient subjected to the inverse quantization for reconstruction into a frame in a spatial domain; and
creating the reconstructed frame using the motion vectors and a temporal residual frame.

18. A recording medium having a computer readable program recorded thereon, the program causing a computer to execute the method of claim 13, wherein the performing of decoding further comprises performing post-processing on the reconstructed frame to improve image quality.
